(19) United States
(12) Patent Application Publication
(10) Pub. No.: US 2024/0303265 A1
(43) Pub. Date: Sep. 12, 2024

(54) LABELING SUPPORT DEVICE, LABELING SUPPORT METHOD, AND PROGRAM

(71) Applicant: NIPPON TELEGRAPH AND TELEPHONE CORPORATION, Tokyo (JP)

(72) Inventors: Shota ORIHASHI, Tokyo (JP); Masato SAWADA, Tokyo (JP)

(73) Assignee: NIPPON TELEGRAPH AND TELEPHONE CORPORATION, Tokyo (JP)

(21) Appl. No.: 18/279,592

(22) PCT Filed: Mar. 1, 2021
(86) PCT No.: PCT/JP2021/007626

§ 371 Date: Aug. 30, 2023

(51) Int. Cl. G06F 16/35; G10L 15/26; G10L 17/02

(52) U.S. Cl. CPC G06F 16/353; G10L 15/26; G10L 17/02

(57) ABSTRACT

A label assignment support device according to the present disclosure includes a preliminary label estimation unit that assigns preliminary labels for each of a plurality of elements, a label assignment work screen output unit that generates a label assignment work screen for each of the plurality of elements and an update operation for labels assigned to the plurality of elements by a user, the label assignment work screen indicating each of the plurality of elements and labels assigned to each of the plurality of elements in association with each other, and a label update unit that, when a label assigned to one of the elements is updated by the update operation via the label assignment work screen, assigns the label after update to the one of the elements.

### TECHNICAL FIELD

The present disclosure relates to a label assignment support device, a label assignment support method, and a program.

### BACKGROUND ART

In recent years, for the purpose of improving the service quality in a contact center, there has been proposed a system that performs voice recognition on call content in real time and automatically presents appropriate information to an operator who is receiving a call by making full use of natural language processing technology.

For example, Non Patent Literature 1 discloses a technique of presenting questions assumed in advance and answers to the questions (FAQ) to an operator in conversation between the operator and a customer. In this technology, conversation between an operator and a customer is subjected to voice recognition, and is converted into a semantic utterance text by “utterance end determination” for determining whether the speaker has finished speaking. Next, “service scene estimation” for estimating in which service scene in conversation the utterance corresponding to the utterance text is, such as greetings by the operator, confirmation of a requirement of the customer, response to the requirement, or closing of the conversation, is performed. The conversation is structured by the “service scene estimation”. From a result of the “service scene estimation”, “FAQ retrieval utterance determination” for extracting utterance including a requirement of the customer or utterance in which the operator confirms a requirement of the customer is performed. Retrieval using a retrieval query based on the utterance extracted by the “FAQ retrieval utterance determination” is performed on a database of the FAQ prepared in advance, and a retrieval result is presented to the operator.

For the above-described “utterance end determination”, “service scene estimation”, and “FAQ retrieval utterance determination”, a model constructed by learning training data in which labels for classifying utterance are assigned to utterance texts using a deep neural network or the like is used. Therefore, the “utterance end determination”, the “service scene estimation”, and the “FAQ retrieval utterance determination” can be regarded as a series of labeling problems for labeling a series of elements (utterance in conversation). Non Patent Literature 2 describes a technique of estimating a service scene by learning a large amount of training data in which labels corresponding to service scenes including a series of utterance is assigned to the utterance using a deep neural network including long and short term memory.

### CITATION LIST

### Non Patent Literature

Non Patent Literature 1: Takaaki Hasegawa, Yuichiro Sekiguchi, Setsuo Yamada, Masafumi Tamoto, “Automatic Recognition Support System That Supports Operator Service,” NTT Technical Journal, vol. 31, no. 7, pp. 16-19, July 2019. Non Patent Literature 2: R. Masumura, S. Yamada, T. Tanaka, A. Ando, H. Kamiyama, and Y. Aono, “Online Call Scene Segmentation of Contact Center Dialogues based on Role Aware Hierarchical LSTM-RNNs,” Asia-Pacific Signal and Information Processing Association Annual Summit and Conference (APSIPA ASC), November 2018.

### SUMMARY OF INVENTION

### Technical Problem

In techniques described in Non Patent Literature 1 and 2 described above, a large amount of training data is required in order to set the estimation accuracy to a level for practical use. For example, according to Non Patent Literature 1, high estimation accuracy can be obtained by training data being created from conversation logs of a call center of about 1000 calls and a model being learned. The training data is created by a worker assigning a label to each utterance text while referring to utterance texts obtained by voice recognition of utterance voice.

FIG. 13 is a diagram illustrating an example of assignment of labels to utterance texts. FIG. 13 illustrates an example in which labels are assigned to utterance texts corresponding to utterance in conversation between an operator and a customer (hereinafter, the utterance texts corresponding to utterance may be simply referred to as “utterance texts”). In FIG. 13, utterance texts of the operator are indicated by solid line balloons, and utterance texts of the customer are indicated by dotted line balloons.

In the example illustrated in FIG. 13, by utterance end labels each indicating whether the utterance is utterance end utterance being assigned to respective utterance texts, training data for “utterance end determination” is created. Furthermore, by scene labels each indicating the service scene including the utterance being assigned to the respective utterance texts, training data for “service scene estimation” is created. Furthermore, by requirement labels each indicating that the utterance is utterance indicating a requirement of the customer being assigned to utterance indicating a requirement of the customer among utterance included in a service scene of “grasping requirement” for grasping a requirement of the customer, and requirement confirmation labels each indicating that the utterance is utterance for confirming a requirement of the customer being assigned to utterance for confirming a requirement of the customer by the operator, training data for “FAQ retrieval utterance determination” is created.

There is an issue that it takes enormous work time to create a large amount of training data as illustrated in FIG. 13. Furthermore, in the example illustrated in FIG. 13, labels of a plurality of items have hierarchical structure. Specifically, a requirement label or a requirement confirmation label is assigned to an utterance text to which a scene label of “grasping of requirement” is assigned. That is, the scene labels are higher labels, and the requirement labels/the requirement confirmation labels are lower labels in the structure. In a case where labels including a plurality of items having such hierarchical structure are assigned by a worker in a state where no guidelines are indicated, there is an issue that a burden on the worker increases.

Therefore, there is a demand for a technique that enables a worker to more easily and efficiently assign labels.

An object of the present disclosure made in view of the above issues is to provide a label assignment support device, a label assignment support method, and a program that enable a worker to more easily and efficiently assign labels.

### Solution to Problem

In order to solve the above issues, a label assignment support device according to the present disclosure is a label assignment support device that supports label assignment for each of a plurality of elements, the label assignment support device including a preliminary label estimation unit that estimates preliminary labels that are labels for each of the plurality of elements using an existing model prepared in advance and assigns the preliminary labels to each of the plurality of elements, an output unit that generates a label assignment work screen for an update operation for labels assigned to the plurality of elements by a user in which each of the plurality of elements and labels assigned to each of the plurality of elements are associated with each other, the label assignment work screen indicating each of the plurality of elements and labels assigned to each of the plurality of elements in association with each other, and outputs the label assignment work screen to an external input and output interface, and a label update unit that, when a label assigned to one of the elements is updated by the update operation via the label assignment work screen, assigns the label after update to the one of the elements.

Furthermore, in order to solve the above issues, a label assignment support device according to the present disclosure is a label assignment support device that supports label assignment for each of a plurality of elements, the label assignment support device including an output unit that generates a label assignment work screen for an update operation for labels assigned to the plurality of elements by a user, the label assignment work screen indicating each of the plurality of elements and labels assigned to each of the plurality of elements in association with each other, and outputs the label assignment work screen to an external input and output interface, in which the labels include labels of a plurality of items, and the output unit arranges the plurality of elements in a line, and sorts and arranges labels of the plurality of items on one side and another side of elements corresponding to corresponding labels on the basis of structure of labels of the plurality of items on the label assignment work screen.

Furthermore, in order to solve the above issues, a label assignment support device according to the present disclosure is a label assignment support device that supports label assignment for each of a plurality of elements, the label assignment support device including an output unit that generates a label assignment work screen for an update operation for labels assigned to the plurality of elements by a user, the label assignment work screen indicating each of the plurality of elements and labels assigned to each of the plurality of elements in association with each other, and outputs the label assignment work screen to an external input and output interface, in which the labels include labels of a plurality of items, and the output unit, when a label to be updated is selected or a label is updated on the label assignment work screen, changes a display mode of the label to be updated or a label associated with the updated label on the basis of hierarchical structure of labels of the plurality of items.

Furthermore, in order to solve the above issues, a label assignment support method according to the present disclosure is a label assignment support method for supporting label assignment for each of a plurality of elements, the label assignment support method including a step of estimating preliminary labels that are labels for each of the plurality of elements using an existing model prepared in advance and assigning the preliminary labels to each of the plurality of elements, a step of generating a label assignment work screen for an update operation for labels assigned to the plurality of elements by a user, the label assignment work screen indicating each of the plurality of elements and labels assigned to each of the plurality of elements in association with each other, and outputting the label assignment work screen to an external input and output interface, and a step of, when a label assigned to one of the elements is updated by the update operation via the label assignment work screen, assigning the label after update to the one of the elements.

Furthermore, in order to solve the above issues, a program according to the present disclosure causes a computer to function as the label assignment support device described above.

### Advantageous Effects of Invention

According to a label assignment support device, a label assignment support method, and a program according to the present disclosure, a worker can more easily and efficiently assign labels.

### BRIEF DESCRIPTION OF DRAWINGS

FIG. 1 is a block diagram illustrating a schematic configuration of a computer that functions as a label assignment support device according to a first embodiment of the present disclosure.

FIG. 2 is a diagram illustrating a functional configuration example of the label assignment support device according to the first embodiment of the present disclosure.

FIG. 3 is a flowchart illustrating an example of operation of the label assignment support device illustrated in FIG. 2.

FIG. 4 is a diagram illustrating an example of a label assignment work screen generated by a label assignment work screen output unit illustrated in FIG. 2.

FIG. 5 is a diagram illustrating a configuration example of a label assignment support device according to a second embodiment of the present disclosure.

FIG. 6 is a flowchart illustrating an example of operation of the label assignment support device illustrated in FIG. 5.

FIG. 7 is a diagram illustrating a configuration example of a label assignment support device according to a third embodiment of the present disclosure.

FIG. 8 is a diagram illustrating an example of a label assignment work screen generated by a label assignment work screen output unit illustrated in FIG. 7.

FIG. 9 is a diagram illustrating an example of a waveform image generated by a waveform image generation unit illustrated in FIG. 7.

FIG. 10 is a flowchart illustrating an example of operation of the label assignment support device illustrated in FIG. 7.

FIG. 11A is a diagram illustrating an example of a first label assignment work screen.

FIG. 11B is a diagram illustrating an example of a second label assignment work screen.

FIG. 12 is a diagram illustrating comparison results of work efficiency of label assignment by a conventional method and a method according to the present disclosure.

FIG. 13 is a diagram illustrating an example of structure of labels including a plurality of items.

### DESCRIPTION OF EMBODIMENTS

Hereinafter, embodiments of the present disclosure will be described with reference to the drawings.

### First Embodiment

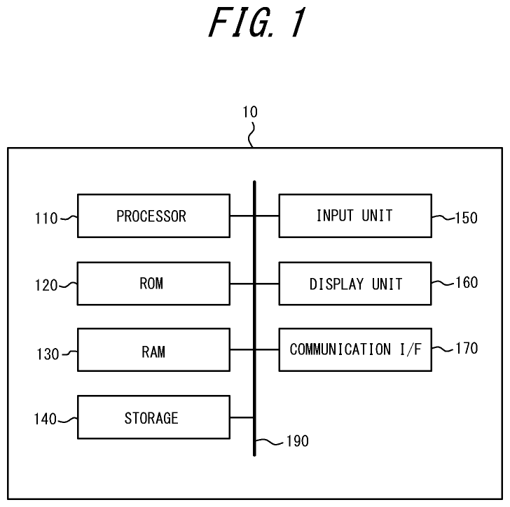

FIG. 1 is a block diagram illustrating a hardware configuration in a case where a label assignment support device 10 according to a first embodiment of the present disclosure is a computer capable of executing a program command. Here, the computer may be a general-purpose computer, a dedicated computer, a workstation, a personal computer (PC), an electronic note pad, or the like. The program command may be a program code, code segment, or the like for executing a necessary task.

As illustrated in FIG. 1, the label assignment support device 10 includes a processor 110, a read only memory (ROM) 120, a random access memory (RAM) 130, a storage 140, an input unit 150, a display unit 160, and a communication interface (I/F) 170. The components are communicably connected to each other via a bus 190. Specifically, the processor 110 is a central processing unit (CPU), a micro processing unit (MPU), a graphics processing unit (GPU), a digital signal processor (DSP), a system on a chip (SoC), or the like and may be configured by the same or different types of a plurality of processors.

The processor 110 executes control of the components and various types of arithmetic processing. That is, the processor 110 reads a program from the ROM 120 or the storage 140 and executes the program using the RAM 130 as a working area. The processor 110 executes control of the above components and various types of arithmetic processing according to a program stored in the ROM 120 or the storage 140. In the present embodiment, a program according to the present disclosure is stored in the ROM 120 or the storage 140.

The program may be provided in a form in which the program is stored in a non-transitory storage medium, such as a compact disk read only memory (CD-ROM), a digital versatile disk read only memory (DVD-ROM), and a universal serial bus (USB) memory. The program may be downloaded from an external device via a network.

The ROM 120 stores various programs and various types of data. The RAM 130 temporarily stores a program or data as a working area. The storage 140 includes a hard disk drive (HDD) or a solid state drive (SSD) and stores various programs including an operating system and various types of data.

The input unit 150 includes a pointing device such as a mouse and a keyboard and is used to perform various inputs.

The display unit 160 is, for example, a liquid crystal display, and displays various types of information. A touch panel system may be adopted so that the display unit 160 can function as the input unit 150.

The communication interface 170 is an interface for communicating with another device such as an external device (not illustrated), and for example, a standard such as Ethernet (registered trademark), FDDI, and Wi-Fi (registered trademark) is used.

Next, a functional configuration of the label assignment support device 10 according to the present embodiment will be described.

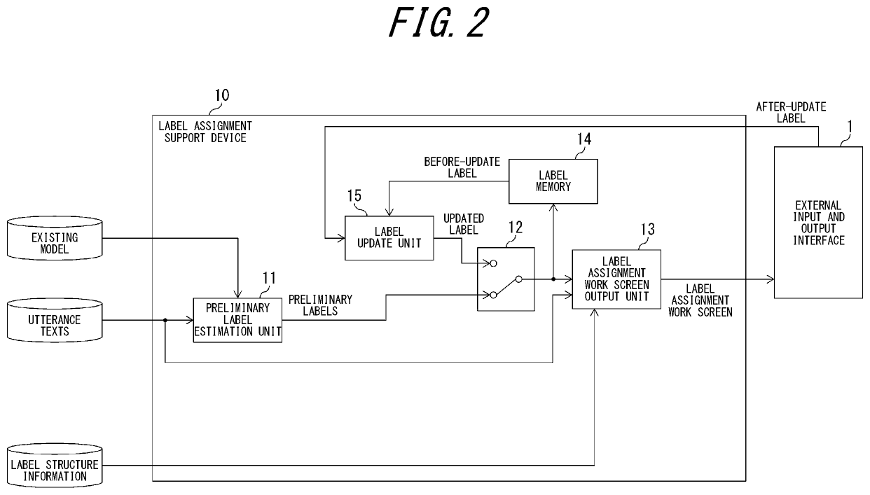

FIG. 2 is a diagram illustrating a functional configuration example of the label assignment support device 10 according to the present embodiment. The label assignment support device 10 according to the present embodiment supports label assignment for each of a plurality of elements in series by a worker who creates training data. Hereinafter, an example in which labels are assigned to utterance texts obtained by performing voice recognition on utterance in conversation by a plurality of speakers (operator and customer) at a contact center will be described. Furthermore, hereinafter, labels include labels of a plurality of items having hierarchical structure. Specifically, an example in which utterance end labels, scene labels, and requirement labels/requirement confirmation labels are assigned will be described. As described above, the scene labels and the requirement labels/requirement confirmation labels have hierarchical structure in which the scene labels are higher labels and the requirement labels/requirement confirmation labels are lower labels. However, the present disclosure is not limited to this example, and can be applied to assignment of a label to each of a plurality of any elements. Furthermore, an utterance text may be not only utterance in a call converted into a text, but also utterance in text conversation such as chat. Furthermore, a speaker in conversation is not limited to a human, and may be a robot, a virtual agent, or the like.

As illustrated in FIG. 2, the label assignment support device 10 according to the present embodiment includes a preliminary label estimation unit 11, a switching unit 12, a label assignment work screen output unit 13 as an output unit, a label memory 14, and a label update unit 15. The preliminary label estimation unit 11, the switching unit 12, the label assignment work screen output unit 13, and the label update unit 15 may be configured by dedicated hardware such as an application specific integrated circuit (ASIC) or a field-programmable gate array (FPGA), or may be configured by one or more processors as described above. The label assignment support device 10 includes a storage unit, and the storage unit includes at least a label memory 14.

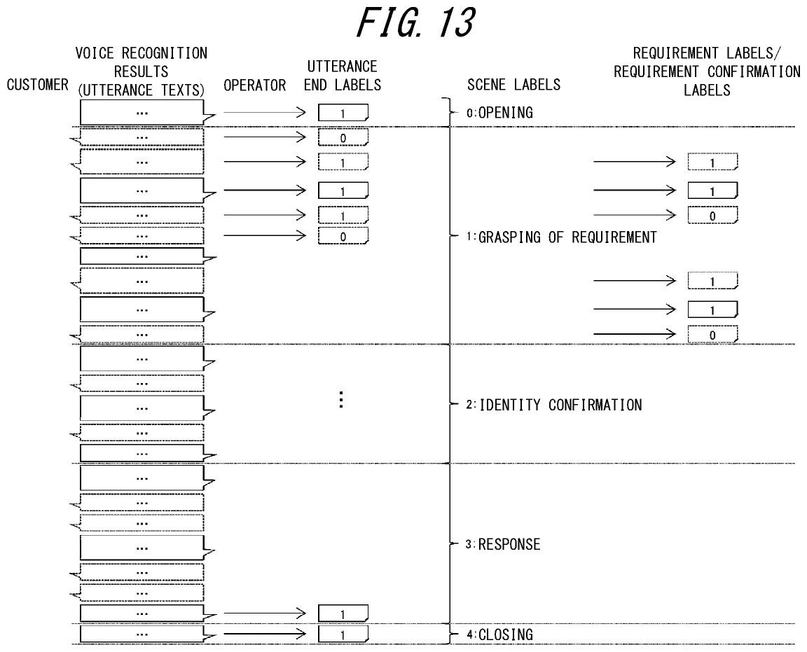

A plurality of utterance texts (elements) included in conversation as illustrated in FIG. 13 is sequentially input to the preliminary label estimation unit 11. The preliminary label estimation unit 11 performs preliminary label estimation processing of estimating and assigning labels (preliminary labels) such as utterance end labels, scene labels, requirement labels, and requirement confirmation labels to each of the plurality of input utterance texts using an existing model prepared in advance.

The existing model is, for example, a model obtained by learning a small amount of training data created by a conventional method in which a worker manually assigns all labels, a model created for a contact center different from a contact center in which a model obtained by learning training data created using the label assignment support device 10 (desired model) is used, a general-purpose model applicable to a plurality of contact centers, or the like. That is, the existing model is, for example, a model constructed by learning a smaller amount of training data than the desired model, or a model constructed for a target different from a target to which the desired model is applied. Therefore, in a system to which the desired model is usually applied, the existing model has lower label estimation accuracy than the desired model.

The preliminary label estimation unit 11 outputs the estimated preliminary labels to the switching unit 12.

When the preliminary labels are output from the preliminary label estimation unit 11, the switching unit 12 outputs the preliminary labels to the label assignment work screen output unit 13 and the label memory 14. Furthermore, when an updated label is output from the label update unit 15 to be described below, the switching unit 12 outputs the updated label to the label assignment work screen output unit 13 and the label memory 14.

The label assignment work screen output unit 13 receives labels output from the switching unit 12 (preliminary labels or updated label), the utterance texts, and label structure information. The label structure information is information regarding label structure of a target system, information regarding whether long-term context should be considered in assigning each of the labels, or the like. A label for which long-term context should be considered is a label in which the label assigned to an utterance text should be determined on the basis of the content of a plurality of utterance texts including the utterance text. In the example described above, the label for which long-term context should be considered is, for example, a scene label. Note that, in the present embodiment, since assignment of labels to utterance texts in conversation between an operator and a customer is taken as an example, the content of a plurality of utterance texts is considered for specific labels, but the present disclosure is not limited thereto. In short, the label structure information may include information regarding whether a label to be assigned to a certain element should be determined on the basis of a plurality of elements including the element.

On the basis of the input utterance texts, labels, and label structure information, the label assignment work screen output unit 13 generates a label assignment work screen for an update operation via which a worker (user) who assigns labels updates (corrects) a label assigned to an utterance text. The label assignment work screen output unit 13 outputs the generated label assignment work screen to an external input and output interface 1. As described above, the label assignment work screen output unit 13 generates the label assignment work screen, performs label assignment work screen output processing of outputting the label assignment work screen to the external input and output interface 1, and displays the label assignment work screen on the external input and output interface 1.

The external input and output interface 1 is a device used for assignment work of labels to utterance texts by a worker. When an update operation of updating a label assigned to an utterance text is performed via the displayed label assignment work screen, the external input and output interface 1 outputs the label to the label assignment support device 10 as an after-update label. The external input and output interface 1 may have any configuration as long as the external input and output interface 1 has a function of communicating with the label assignment support device 10, a function of displaying a label assignment work screen, and a function of receiving operation inputs by a worker. Details of the label assignment work screen will be described below.

The label memory 14 stores the labels output from the switching unit 12. In a case where label update processing to be described below is performed by the label update unit 15, the label memory 14 outputs the stored labels to the label update unit 15 as before-update labels.

When the label of the utterance text updated by the worker (after-update label) is output from the external input and output interface 1, the label update unit 15 performs label update processing of replacing a before-update label assigned to the utterance text output from the label memory 14 with the after-update label and assigning the after-update label to the utterance text. As described above, when a label assigned to an utterance text (element) is updated by an update operation via the label assignment work screen, the label update unit 15 assigns an after-update label to the utterance text. Identification information for identifying before-update labels may be input to the label update unit 15 instead of the before-update labels.

The label update unit 15 outputs the label assigned to the utterance text by the label update processing (after-update label) to the switching unit 12 as the updated label. As described above, when the updated label is output from the label update unit 15, the switching unit 12 outputs the updated label to the label assignment work screen output unit 13. In response to the output of the updated label from the switching unit 12, the label assignment work screen output unit 13 newly generates a label assignment work screen and outputs the label assignment work screen to the external input and output interface 1. In this manner, the label assignment work screen in which label update is reflected by an update operation by a worker is displayed. Until an end operation of ending label assignment work is performed, label update and display of a label assignment work screen in which the update content is reflected are repeated.

Note that, in the present embodiment, when an update operation is performed for updating a preliminary label assigned to an utterance text after assigning preliminary labels to utterance texts using the existing model, the after-update label is assigned to the utterance text. Therefore, since a worker only needs to update labels that need to be updated, label assignment can be easily performed. Furthermore, labels can be more easily assigned as compared with a case where labels are assigned in a state where there are no guidelines for label assignment, and thus working time can be shortened. Therefore, according to the label assignment support device 10 according to the present embodiment, a worker can more easily and efficiently assign labels.

Note that the external input and output interface 1 or the label assignment support device 10 may accumulate histories of label update by update operations. Furthermore, the external input and output interface 1 may display the accumulated histories of label update. Furthermore, when an end operation of label assignment work is performed, labels assigned to utterance texts at the time when the end operation is performed may be determined as labels of the utterance texts.

Next, operation of the label assignment support device 10 according to the present embodiment will be described.

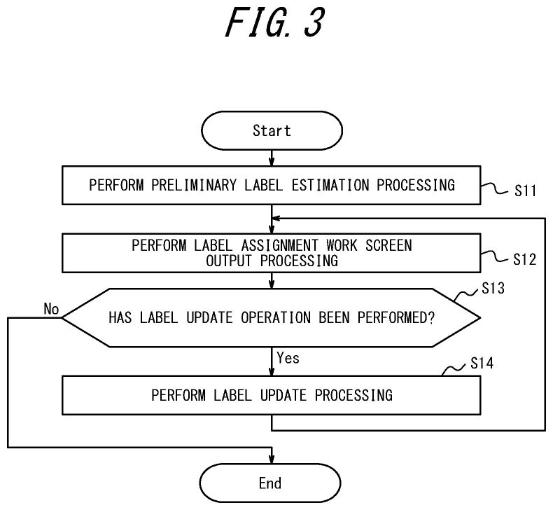

FIG. 3 is a flowchart illustrating an example of the operation of the label assignment support device 10, and is a diagram for describing a label assignment support method by the label assignment support device 10 according to the present embodiment.

When a plurality of utterance texts is input, the preliminary label estimation unit 11 performs preliminary label estimation processing of estimating preliminary labels for each of the plurality of input utterance texts using the existing model prepared in advance (step S11). The preliminary labels estimated by the preliminary label estimation unit 11 are input to the label assignment work screen output unit 13 via the switching unit 12.

When the labels are input via the switching unit 12, the label assignment work screen output unit 13 performs label assignment work screen output processing of generating a label assignment work screen including the utterance texts and the input labels, and outputting the label assignment work screen to an interface that performs external input and output (step S12).

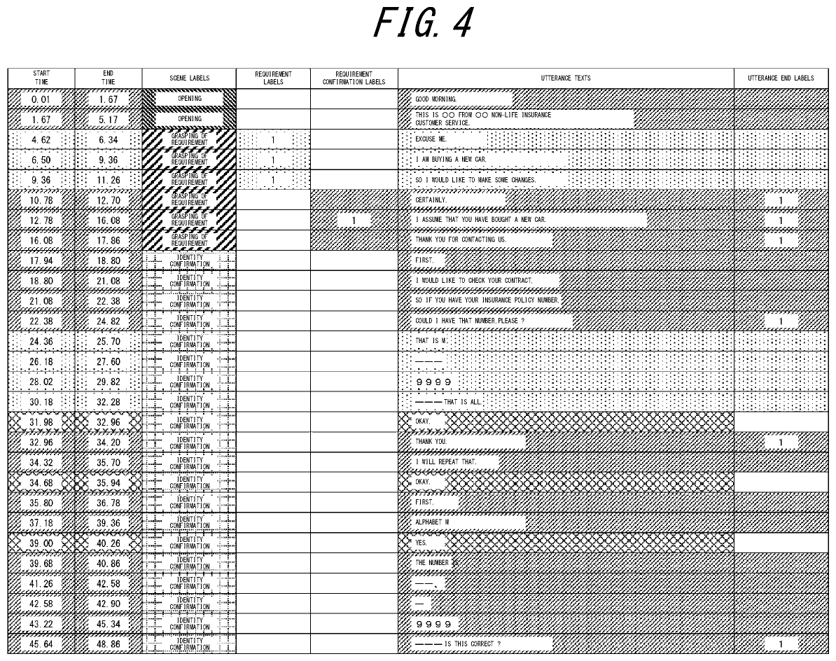

FIG. 4 is a diagram illustrating an example of the label assignment work screen.

As illustrated in FIG. 4, the label assignment work screen output unit 13 arranges the utterance texts of an operator and a customer in a line in chronological order on the label assignment work screen. Furthermore, the label assignment work screen output unit 13 arranges the start time at which the utterance starts, the end time at which the utterance ends, and the labels assigned to the utterance (scene labels, requirement labels, requirement confirmation labels, and utterance end labels) in association with the respective utterance texts. As illustrated in FIG. 4, the label assignment work screen output unit 13 may display utterance texts of the operator and utterance text of the customer in different colors. Note that, in FIG. 4, a difference in color is expressed by a difference in hatching.

As illustrated in FIG. 4, the label assignment work screen output unit 13 may arrange a plurality of elements in a line, and sort and arrange the labels of a plurality of items on one side and the other side of the elements corresponding to the labels on the basis of the structure of the labels of the plurality of items on the label assignment work screen.

In general, arranging labels in areas close to utterance texts facilitates assignment work of the labels. Therefore, by the utterance texts being arranged in a line and the labels of the plurality of items being sorted and arranged on both sides of the utterance texts, the areas close to the utterance texts can be effectively utilized and the efficiency of assignment work of the labels can be improved.

In the example illustrated in FIG. 4, the scene labels, the requirement labels, and the requirement confirmation labels are arranged on the left side of the utterance texts, and the utterance end labels are arranged on the right side of the speed texts. As described above, in assigning a scene label, a requirement label, and a requirement confirmation label to an utterance text, not only the utterance text but also the content of utterance texts before and after the utterance text are considered. That is, a scene label, a requirement label, and a requirement confirmation label for an utterance text are labels for which long-term context should be considered. On the other hand, assignment of an utterance end label to an utterance text only requires consideration of mainly only the utterance text. Therefore, the label assignment work screen output unit 13 may arrange the labels for which long-term context should be considered (labels in which the labels for certain elements are determined on the basis of a plurality of elements including the elements) on the left side of the utterance texts. Furthermore, the label assignment work screen output unit 13 may arrange labels for which long-term context is not considered (labels in which labels for certain elements are determined mainly on the basis of only the elements) on the right side of the utterance texts.

Furthermore, in the example illustrated in FIG. 4, the label assignment work screen output unit 13 arranges the requirement labels and the requirement confirmation labels closer to the utterance texts than the scene labels. As described above, a requirement label or a requirement confirmation label is assigned to an utterance text to which a scene label of “grasping of requirement” is assigned. That is, the scene labels are higher labels, and the requirement labels/requirement confirmation labels are lower labels. Therefore, the label assignment work screen output unit 13 may arrange labels having a lower hierarchy closer to the utterance texts among labels of a plurality of items having hierarchical structure. Since assignment work of the lower labels is facilitated by the utterance texts being referred to, the work efficiency can be improved in this way. Furthermore, the utterance end labels are mainly assigned with the ends of the utterance being mainly focused on. Therefore, by the utterance end labels being arranged on the right side of the utterance texts, a worker can easily refer to the ends of the utterance texts, and thus the work efficiency of assignment of the utterance end labels can be improved.

Furthermore, when a label to be updated is selected by a worker or a certain label is updated by a worker on the label assignment work screen, the label assignment work screen output unit 13 may change a display mode of the label to be updated or labels associated with the updated label (higher label and lower label) on the basis of the hierarchical structure of the label of the plurality of items. In the example illustrated in FIG. 4, it is assumed that a scene label of “grasping of requirement” is selected as a label to be updated or updated. In this case, the label assignment work screen output unit 13 changes the display mode by, for example, changing the display colors of a requirement label and a requirement confirmation utterance label that are lower labels of the scene label. As a result, a worker can easily grasp labels associated with a label to be updated, and the work efficiency of label assignment can be improved.

Furthermore, in a case where inconsistency occurs between associated labels when updating a higher label or a lower label, the label assignment work screen output unit 13 may change the display mode of the labels in which the inconsistency occurs. In this way, inconsistency can be prevented from occurring between the labels of the plurality of items having the hierarchical structure, and occurrence of an error in label assignment can be reduced, and thus the work efficiency of label assignment can be improved.

Furthermore, the label assignment work screen output unit 13 may make the display mode of an utterance text that is not a target of training data, for example, a short utterance text such as a filler and “yes” different from other utterance texts. In this way, workers can easily grasp an utterance text in which a label does not need to be assigned, and thus the work efficiency can be improved.

Referring back to FIG. 2, the label update unit 15 determines whether a label update operation has been performed (step S13). Specifically, the label update unit 15 determines whether a label update operation has been performed on the basis of whether an after-update label has been output from the external input and output interface 1.

When an after-update label is not output from the external input and output interface 1 and, for example, an end operation is performed, the label update unit 15 determines that a label update operation has not been performed (step S13: No). When the label update unit 15 determines that a label update operation has not been performed, the label assignment support device 10 ends the processing.

When an after-update label is output from the external input and output interface 1 and it is determined that a label update operation has been performed (step S13: Yes), the label update unit 15 performs label update processing of assigning the after-update label to an utterance text including a label that has been updated by the update operation (step S14). After the label update processing, the processing returns to the processing of step S12, and a label assignment work screen including the after-update label is generated by the label assignment work screen output unit 13 and output to the external input and output interface 1.

As described above, the label assignment support device 10 according to the present embodiment includes the preliminary label estimation unit 11, the label assignment work screen output unit 13, and the label update unit 15. The preliminary label estimation unit 11 estimates preliminary labels for each of a plurality of elements using the existing model prepared in advance, and assigns the preliminary labels to each of the plurality of elements. The label assignment work screen output unit 13 generates a label assignment work screen for a label update operation in which each of the plurality of elements and labels assigned to each of the plurality of elements are in association with each other, and outputs the label assignment work screen to the external input and output interface 1. When a label assigned to an element is updated by an update operation via the label assignment work screen, the label update unit 15 assigns the label after update to the element.

Furthermore, the label assignment support method according to the present embodiment includes a step of assigning preliminary labels (step S11), a step of outputting a label assignment work screen to the external input and output interface 1 (step S12), and a step of updating a label (step S14). In the step of assigning preliminary labels, preliminary labels for each of a plurality of elements are estimated using the existing model prepared in advance, and assigned to each of the plurality of elements. In the step of outputting a label assignment work screen to the external input and output interface 1, a label assignment work screen for a label update operation in which each of the plurality of elements and labels assigned to each of the plurality of elements are in association with each other is generated, and output to the external input and output interface 1. In the step of updating a label, when a label assigned to an element is updated by an update operation via the label assignment work screen, the label after update is assigned to the element.

When an update operation is performed after preliminary labels are assigned to utterance texts using the existing model, a worker only needs to update labels that need to be updated by assigning after-update labels to utterance texts, and thus label assignment can be easily performed. Furthermore, labels can be more easily assigned as compared with a case where labels are assigned in a state where there are no guidelines for label assignment, and thus working time can be shortened. Therefore, according to the present disclosure, a worker can more easily and efficiently assign labels. Furthermore, since preliminary labels are obtained as guides for label assignment, certain guidelines for label assignment can be presented to a worker who is not skilled in label assignment work, and the worker can perform the label assignment work using the guidelines as guides, and thus the practice period can be shortened.

Note that the preliminary label estimation unit 11 does not necessarily need to estimate preliminary labels for all the labels. For example, the preliminary label estimation unit 11 may estimate preliminary labels only for the scene labels and the requirement/requirement confirmation labels, and may not estimate preliminary labels for the utterance end labels. In this case, in the label assignment work screen illustrated in FIG. 4, the labels for which preliminary labels have not been estimated may be blank, and a worker may assign labels to the blank portions. The labels for which preliminary labels are estimated or the labels for which preliminary labels are not estimated may be designated in advance by a worker or the like.

As a case where preliminary labels of some labels are not estimated as described above, there is a case where estimation accuracy of specific preliminary labels is very poor, and the work efficiency is better in a case where a worker assigns labels than a case where the worker corrects the preliminary labels.

### Second Embodiment

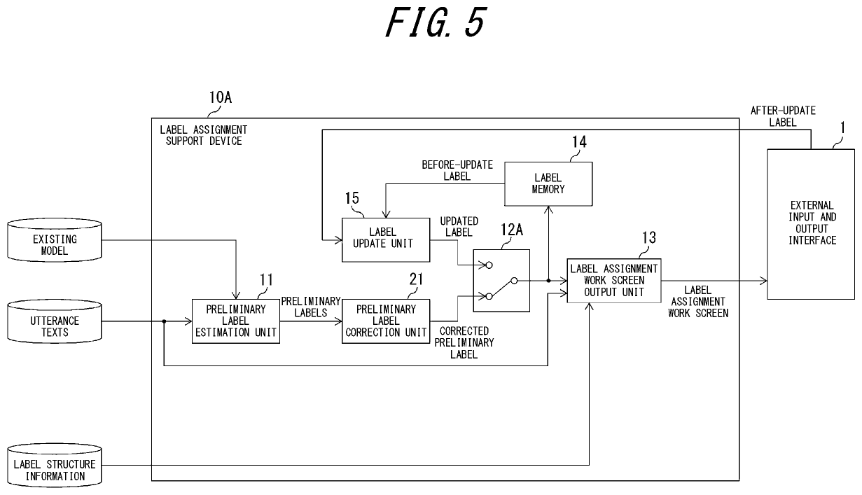

FIG. 5 is a diagram illustrating a configuration example of a label assignment support device 10A according to a second embodiment of the present disclosure. In FIG. 5, configurations similar to those in FIG. 2 are denoted by the same reference signs, and description thereof will be omitted.

The label assignment support device 10A according to the present embodiment is different from the label assignment support device 10 according to the first embodiment in that a preliminary label correction unit 21 is added and that the switching unit 12 is changed to a switching unit 12A.

The preliminary label correction unit 21 receives preliminary labels estimated by a preliminary label estimation unit 11. The preliminary label correction unit 21 performs preliminary label correction processing of correcting a label determined to be erroneous on the basis of a predetermined rule among the input preliminary labels. The preliminary label correction unit 21 outputs a label after the preliminary label correction processing (corrected label for a label that is determined to be erroneous among the preliminary labels of each of a plurality of utterance texts) to the switching unit 12A as a corrected preliminary label.

As the preliminary label correction processing, for example, the preliminary label correction unit 21 corrects a scene label such that an extremely short service scene including only a single piece of utterance is incorporated into an adjacent service scene. Furthermore, as the preliminary label correction processing, the preliminary label correction unit 21 appropriately divides an utterance text having a long utterance length, and assigns an utterance end label, for example. Furthermore, as the preliminary label correction processing, in a case where an estimated probability of a label estimated by an existing model is an ambiguous value for which it cannot be said that the estimation is necessarily erroneous or correct (for example, value in a predetermined range including 0.5 in a case where the estimated probability is a value in a range of 0 to 1), the preliminary label correction unit 21 determines that the label is undefined.

When the corrected preliminary label is output from the preliminary label correction unit 21, the switching unit 12A outputs the corrected preliminary label to a label assignment work screen output unit 13 and a label memory 14. Furthermore, when an updated label is output from a label update unit 15, the switching unit 12A outputs the updated label to the label assignment work screen output unit 13 and the label memory 14.

Next, operation of the label assignment support device 10A according to the present embodiment will be described.

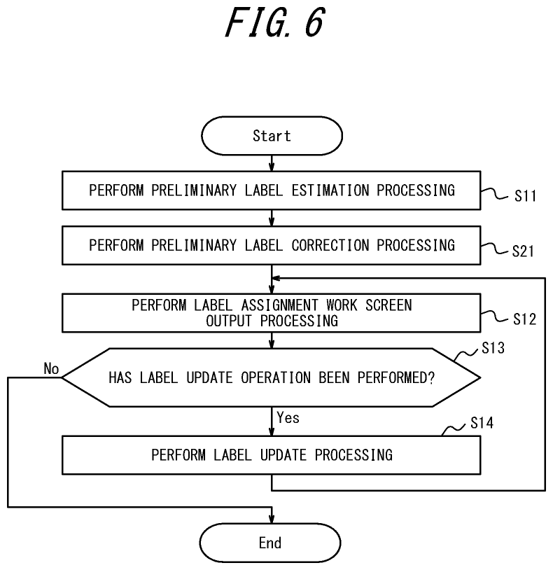

FIG. 6 is a flowchart illustrating an example of the operation of the label assignment support device 10A according to the present embodiment. In FIG. 6, processing similar to the processing in FIG. 3 is denoted by the same reference signs, and description thereof will be omitted.

When preliminary label estimation processing is performed (step S11), the preliminary label correction unit 21 performs preliminary label correction processing of correcting a label determined to be erroneous on the basis of the predetermined rule among estimated preliminary labels (step S21). The preliminary label correction unit 21 outputs the corrected preliminary label to the switching unit 12A. The switching unit 12A outputs the corrected preliminary label output from the preliminary label correction unit 21 to the label assignment work screen output unit 13 and the label memory 14. Hereinafter, similarly to the first embodiment, the label assignment work screen output unit 13 performs label assignment work screen output processing (step S12).

As described above, in the present embodiment, the label assignment support device 10A includes the preliminary label correction unit 21. The preliminary label correction unit 21 corrects a label determined to be erroneous on the basis of the predetermined rule among estimated preliminary labels.

Accordingly, since a label determined to be erroneous on the basis of the predetermined rule is corrected and then a label assignment work screen is output, the necessity for a worker to update labels is reduced, and the work efficiency can be improved.

### Third Embodiment

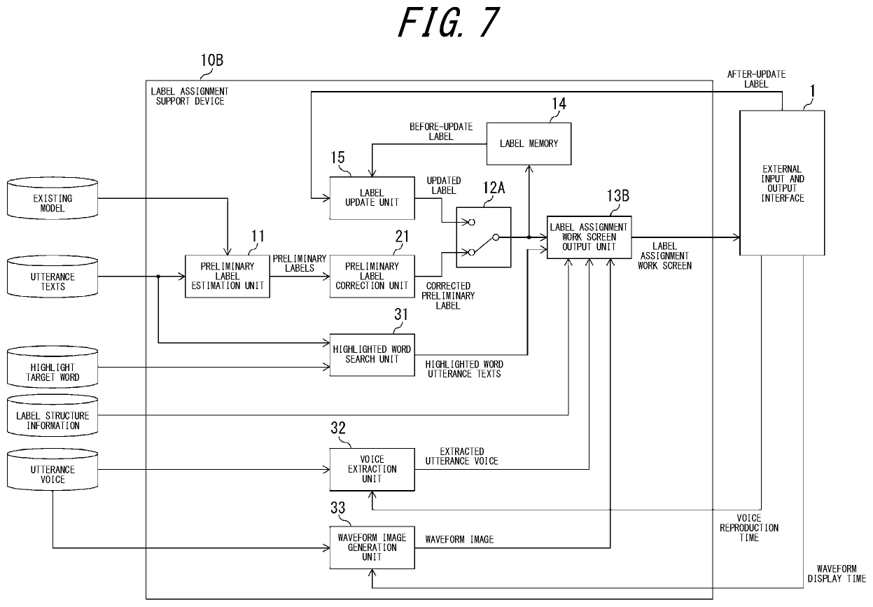

FIG. 7 is a diagram illustrating a configuration example of a label assignment support device 10B according to a third embodiment of the present disclosure. In FIG. 7, configurations similar to those in FIG. 5 are denoted by the same reference signs, and description thereof will be omitted.

The label assignment support device 10B according to the present embodiment is different from the label assignment support device 10A according to the second embodiment in that a highlighted word search unit 31, a voice extraction unit 32, and a waveform image generation unit 33 are added, and that the label assignment work screen output unit 13 is changed to a label assignment work screen output unit 13B.

The highlighted word search unit 31 receives a highlight target word that is a target word to be highlighted in utterance texts and the utterance texts. The highlight target word is a specific word useful for label assignment work. The highlight target word is, for example, a word such as “contract” assumed to appear in the opening of a service scene of “identity confirmation”. The highlight target word may be designated in advance by a worker. Furthermore, the highlight target word may be automatically determined during label assignment work on the basis of a distribution of the appearance frequencies in respective service scenes of a word appearing unevenly in the service scenes in entire conversation.

The highlighted word search unit 31 performs highlighted word search processing of searching for highlight target words from the utterance texts. The highlighted word search unit 31 determines words searched by highlight processing as highlighted portions, generates highlighted utterance texts in which the highlighted portions in the utterance texts are highlighted, and outputs the highlighted utterance texts to the label assignment work screen output unit 13B.

The voice extraction unit 32 receives utterance voice that is the basis of the utterance texts and voice reproduction time output from an external input and output interface 1. The voice reproduction time is time that is designated by a worker and serves as a start point for reproducing the utterance voice in the conversation. The voice extraction unit 32 performs voice extraction processing of extracting voice utterance from the time designated by the voice reproduction time from the input utterance voice. The voice extraction unit 32 performs voice output processing of outputting the extracted utterance voice to the label assignment work screen output unit 13B.

The waveform image generation unit 33 receives the utterance voice that is the basis of the utterance texts and waveform display time output from the external input and output interface 1. The waveform display time is time that is designated by a worker and serves as a start point for displaying a waveform image indicating the utterance voice in the conversation. The waveform image generation unit 33 performs waveform image generation processing of generating a waveform image of the utterance voice from the time designated by the waveform display time from the input utterance voice. The waveform image generation unit 33 performs waveform image output processing of outputting the generated waveform image to the label assignment work screen output unit 13B.

The label assignment work screen output unit 13B receives a label (corrected preliminary label or updated label) output from a switching unit 12A, the highlighted utterance texts output from the highlighted word search unit 31, and label structure information. The label assignment work screen output unit 13B performs label assignment work screen output processing of generating a label assignment work screen on the basis of the input highlighted utterance texts, label, and label structure information, and outputting the label assignment work screen to the external input and output interface 1.

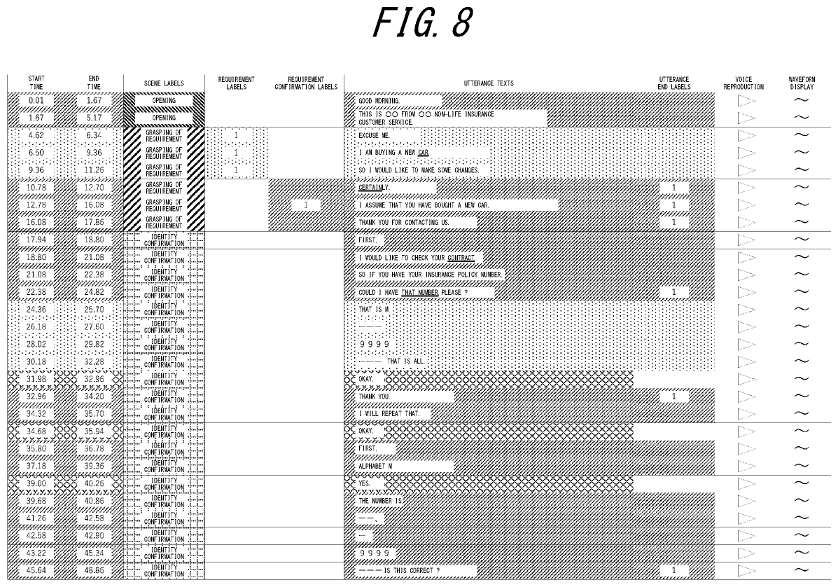

FIG. 8 is a diagram illustrating an example of the label assignment work screen output by the label assignment work screen output unit 13B. In FIG. 8, description of parts similar to those in FIG. 4 will be omitted.

As illustrated in FIG. 8, the label assignment work screen output unit 13B highlights highlighted portions highlighted by the highlighted word search unit 31 in utterance texts by changing the color, underlining the highlighted portions, or the like. In FIG. 8, an example in which the highlighted portions are underlined is illustrated. Furthermore, the label assignment work screen output unit 13B arranges voice reproduction buttons for reproducing utterance voice in the utterance in association with the utterance texts. Furthermore, the label assignment work screen output unit 13 arranges waveform display buttons for displaying waveform images of utterance voice in the utterance in association with the utterance texts.

For example, when a voice reproduction operation of selecting a voice reproduction button is performed, the start time of an utterance text associated with the selected voice reproduction button is output as the voice reproduction time from the external input and output interface 1 to the label assignment support device 10B. When the voice reproduction time is input, the voice extraction unit 32 outputs utterance voice from the voice reproduction time to the label assignment work screen output unit 13B. The label assignment work screen output unit 13B outputs the voice utterance output from the voice extraction unit 32 to the external input and output interface 1, and causes the external input and output interface 1 to reproduce the voice. Note that, as described above, utterance texts may be utterance in conversation via texts such as chat. In this case, the label assignment work screen output unit 13B may output voice corresponding to an utterance text using a technology such as voice synthesis.

The section for which the utterance voice is reproduced can be designated, for example, by a drag operation being performed from a voice reproduction button corresponding to an utterance text for which the reproduction of the utterance voice is started to a voice reproduction button corresponding to an utterance text for which the reproduction of the utterance voice is ended. Furthermore, when the start point for starting reproduction of utterance voice is designated, the reproduction of the utterance voice is started, and for example, the reproduction of the utterance voice may be continued until the end of the utterance voice or until a stop operation is performed.

By utterance voice being reproduced, for example, in a case where the readability of a voice recognition result (utterance text) is low and information for assigning a label cannot be sufficiently obtained using only the utterance text, a worker can confirm the utterance content. As a result, more accurate label assignment can be performed.

Furthermore, for example, when a waveform display operation of selecting a waveform display button is performed, the start time of an utterance text associated with the selected waveform display button is output as the waveform display time from the external input and output interface 1 to the label assignment support device 10B. When the waveform display time is input, the waveform image generation unit 33 generates a waveform image of the utterance voice from the waveform display time, and outputs the waveform image to the label assignment work screen output unit 13B. The label assignment work screen output unit 13B outputs the waveform image output from the waveform image generation unit 33 to the external input and output interface 1, and causes the external input and output interface 1 to display the waveform image.

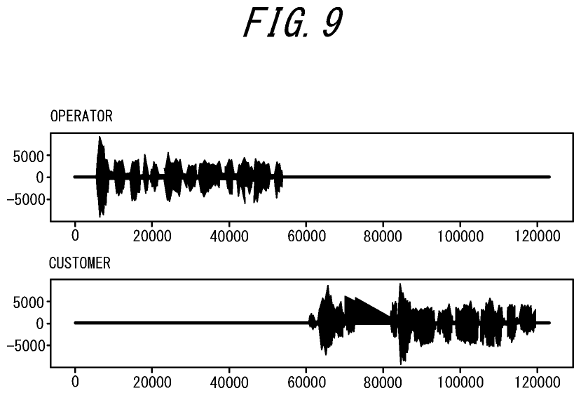

FIG. 9 is a diagram illustrating an example of the waveform image generated by the waveform image generation unit 33.

In a case where the section for which a waveform image is generated includes utterance of an operator and utterance of a customer as illustrated in FIG. 9, the waveform image generation unit 33 generates a waveform image in which a waveform of the utterance voice of the operator and a waveform of the utterance voice of the customer are separated.

The section for which the waveform image is displayed can be designated, for example, by a drag operation being performed from a waveform image button corresponding to an utterance text for which the display of the waveform image is started to a waveform image button corresponding to an utterance text for which the display of the waveform image is ended. For example, when a predetermined display operation such as pressing a waveform display button is performed, the waveform image generation unit 33 displays a waveform image in a section corresponding to the waveform display button. Furthermore, when the start point for starting display of a waveform image is designated, the waveform image generation unit 33 starts the display of the waveform image, and may continue the display of the waveform image until a stop operation is performed.

By a waveform image being performed, for example, a worker who has learned that a section in which only an operator is speaking in small voice is in a hold state of a call, or a topic is switched in a case where the tone is emphasized can assign appropriate labels by referring to the waveform image. Furthermore, by a waveform image being displayed, in a case where only an utterance text of one of the operator and the customer continues for a long period of time, whether there is missing utterance of the other can be simply confirmed. As a result, the work efficiency of label assignment can be improved.

In this manner, by utterance voice being reproduced according to a voice reproduction operation and a waveform image being displayed according to a waveform display operation, information required by a worker can be selected and referred to according to the readability of voice recognition results (utterance texts), the skill and experience of the worker, and the like.

In a case where the readability of an utterance text is determined to be low, the label assignment work screen output unit 13B may perform highlight display such as blinking the voice reproduction button and the waveform display button corresponding to the utterance text. The readability of an utterance text is evaluated by, for example, a mechanism different from the label assignment support device 10B.

Next, operation of the label assignment support device 10B according to the present embodiment will be described.

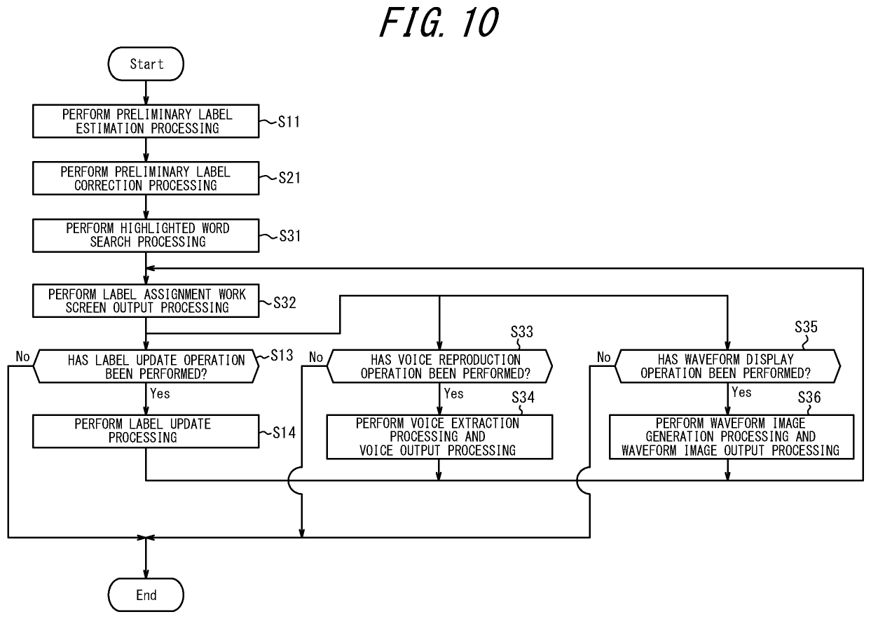

FIG. 10 is a flowchart illustrating an example of the operation of the label assignment support device 10B according to the present embodiment. In FIG. 10, processing similar to the processing in FIG. 6 is denoted by the same reference signs, and description thereof will be omitted.

When preliminary label estimation processing (step S11) and preliminary label correction processing (step S21) are completed, the highlighted word search unit 31 performs highlighted word search processing of searching for highlight target words from utterance texts (step S31). Note that the highlighted word search processing may be performed in parallel with the preliminary label estimation processing and the preliminary label correction processing.

Next, the label assignment work screen output unit 13B performs label assignment work screen output processing of generating a label assignment work screen on the basis of highlighted utterance texts in which the highlight target words are highlighted by the highlighted word search unit 31, labels and label structure information output from the switching unit 12A, and outputting the label assignment work screen to the external input and output interface 1 (step S32). As illustrated in FIG. 8, the label assignment work screen output unit 13B highlights portions highlighted by the highlighted word search unit 31 in the utterance texts by performing display in different colors, underlining, or the like. Furthermore, as illustrated in FIG. 8, the label assignment work screen output unit 13B arranges the voice reproduction buttons for reproducing utterance voice of the utterance and the waveform image buttons for displaying a waveform image of utterance voice of the utterance in association with the respective utterance texts.

When the label assignment work screen output processing is performed, a label update unit 15 determines whether a label update operation has been performed (step S13).

When an after-update label is not output from the external input and output interface 1 and, for example, an end operation is performed, the label update unit 15 determines that a label update operation has not been performed (step S13: No). When the label update unit 15 determines that a label update operation has not been performed, the label assignment support device 10 ends the processing.

When an after-update label is output from the external input and output interface 1 and it is determined that a label update operation has been performed (step S13: Yes), the label update unit 15 performs label update processing of assigning the after-update label to an utterance text including a label that has been updated by the update operation (step S14).

When the label assignment work screen output processing is performed, the voice extraction unit 32 determines whether a voice reproduction operation has been performed (step S33). Specifically, the voice extraction unit 32 determines whether voice reproduction time has been output from the external input and output interface 1.

When it is determined that a voice reproduction operation has been performed (step S33: Yes), the voice extraction unit 32 performs voice extraction processing of extracting utterance voice of utterance from the voice reproduction time from utterance voice of the entire conversation and voice output processing of outputting the utterance voice that is extracted as extracted utterance voice to the label assignment work screen output unit 13B (step S34).

When the voice extraction unit 32 has determined that a voice reproduction operation has not been performed (step S33: No), the label assignment support device 10 ends the processing.

When the label assignment work screen output processing is performed, the waveform image generation unit 33 determines whether a waveform display operation has been performed (step S35). Specifically, the waveform image generation unit 33 determines whether waveform display time has been output from the external input and output interface 1.

When the waveform image generation unit 33 determines that a waveform display operation has not been performed (step S35: No), the label assignment support device 10B ends the processing.

When it is determined that a waveform display operation has been performed (step S35: Yes), the waveform image generation unit 33 performs waveform image generation processing of generating a waveform image of utterance voice from the waveform display time, and waveform image output processing of outputting the generated waveform image to the label assignment work screen output unit 13B (step S36).

After processing of step S14, step S34, or step S36, the label assignment work screen output unit 13B performs label assignment work screen output processing (step S32). In a case where extracted utterance voice is output from the voice extraction unit 32, the label assignment work screen output unit 13B outputs the extracted utterance voice to the external input and output interface 1, and causes the external input and output interface 1 to reproduce the extracted utterance voice. Furthermore, in a case where a waveform image is output from the waveform image generation unit 33, the label assignment work screen output unit 13B outputs the waveform image to the external input and output interface 1, and causes the external input and output interface 1 to display the waveform image.

As described above, the label assignment support device 10B according to the present embodiment includes the highlighted word search unit 31 and the label assignment work screen output unit 13B. The highlighted word search unit 31 searches for highlight target words from utterance texts, and determines the searched words as highlighted portions. The label assignment work screen output unit 13B highlights the words determined as the highlighted portions by the highlighted word search unit 31 in the utterance texts on a label assignment work screen.

Therefore, words useful for label assignment can be highlighted, and the work efficiency of label assignment can be improved.

Furthermore, the label assignment support device 10B according to the present embodiment includes the voice extraction unit 32 and the label assignment work screen output unit 13B. The voice extraction unit 32 extracts utterance voice of utterance selected by a voice reproduction operation. The label assignment work screen output unit 13B outputs the utterance voice extracted by the voice extraction unit 32 to the external input and output interface 1, and causes the external input and output interface 1 to reproduce the utterance voice.

Accordingly, in a case where the readability of an utterance text is low and the utterance content cannot be confirmed, a worker can confirm the utterance content by reproducing the utterance voice, and thus the work efficiency of label assignment can be improved.

Furthermore, the label assignment support device 10B according to the present embodiment includes the waveform image generation unit 33 and the label assignment work screen output unit 13B. The waveform image generation unit 33 generates a waveform image of utterance voice selected by a waveform display operation. The label assignment work screen output unit 13B outputs the waveform image generated by the waveform image generation unit 33 to the external input and output interface 1, and causes the external input and output interface 1 to display the waveform image.

Accordingly, switching of topics can be confirmed from the waveform image, and the presence or absence of missing utterance can be confirmed, and thus the work efficiency of label assignment can be improved.

Note that, in the present embodiment, the description has been given using an example in which the label assignment support device 10B has a function of searching for and highlighting search target words, a function of reproducing utterance voice, and a function of displaying a waveform image, but the present disclosure is not limited thereto. The label assignment support device 10B may include at least one of the above-described three functions. Furthermore, the label assignment support device 10 according to the first embodiment and the label assignment support device 10A according to the second embodiment may include at least one of the above-described three functions. Therefore, when an utterance text is selected via a label assignment work screen, the label assignment work screen output unit 13B may output at least one of utterance voice of utterance corresponding to the selected utterance text or a voice waveform of the utterance voice of the utterance corresponding to the selected utterance text to the external input and output interface 1.

Furthermore, in the first to third embodiments described above, an example has been described in which all labels of a plurality of items assigned to elements (utterance texts) are arranged on one label assignment work screen, but the present disclosure is not limited thereto.

As described above, a plurality of labels may be assigned to an element. The plurality of labels assigned to one element includes labels of an item in which a label can be independently assigned mainly by one element (first labels). The plurality of labels assigned to one element includes labels having hierarchical structure or labels of an item in which a label of one element is determined on the basis of a plurality of elements including the one label (second labels). The first labels are, for example, utterance end labels. As described above, the scene labels and the requirement labels/requirement confirmation labels have the hierarchical structure. Furthermore, for example, the scene labels are assigned in consideration of content of a plurality of utterance texts. Therefore, the second labels are, for example, the scene labels, the requirement labels, and the requirement confirmation labels.

The label assignment work screen output units 13 and 13B may output and display a label assignment work screen for an update operation of the first labels (first label assignment work screen) and a label assignment work screen for an update operation of the second labels (second label assignment work screen) independently on the external input and output interface 1.

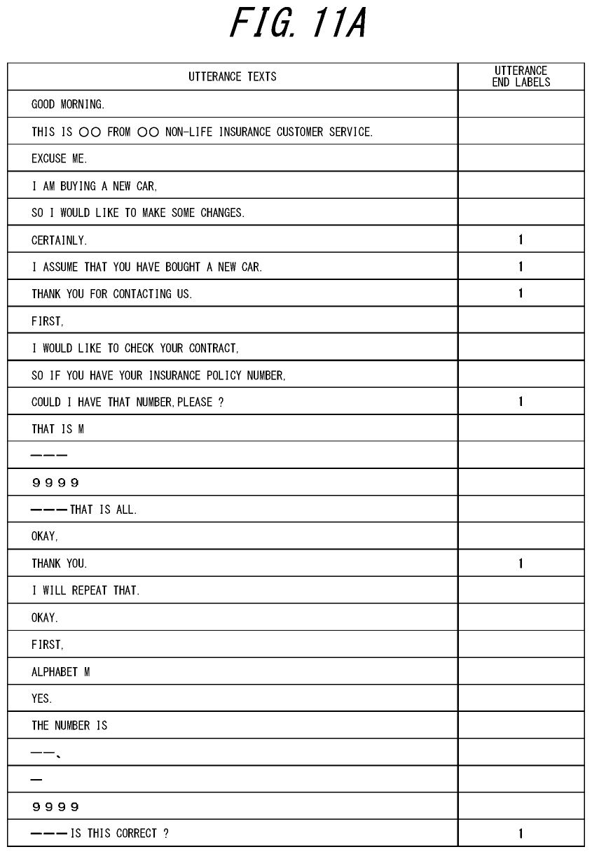

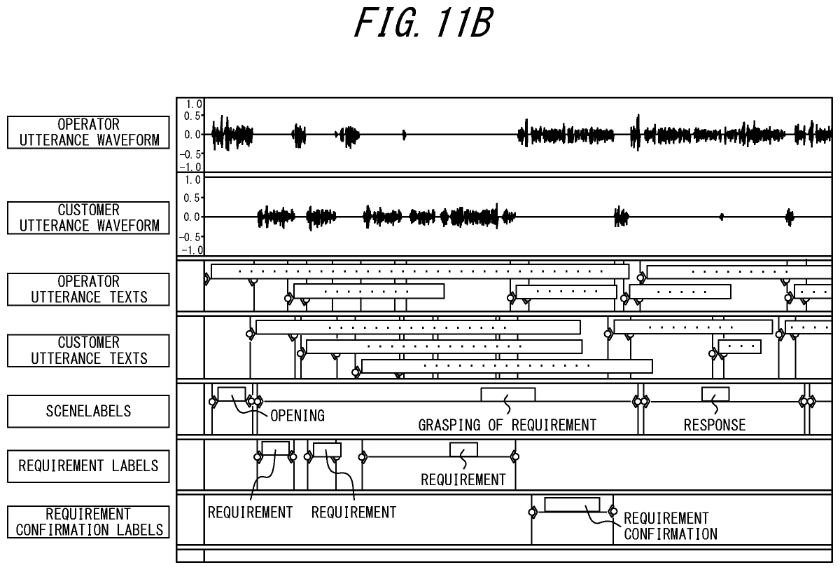

FIG. 11A is a diagram illustrating an example of the first label assignment work screen for an update operation of the first labels. As illustrated in FIG. 11A, the label assignment work screen output units 13 and 13B may arrange utterance texts and utterance end labels in association with each other on the first label assignment work screen.

FIG. 11B is a diagram illustrating an example of the second label assignment work screen for an update operation of the second labels. As illustrated in FIG. 11B, the label assignment work screen output units 13 and 13B may arrange a waveform of utterance voice of an operator and a waveform of utterance voice of a customer on the second label assignment work screen. Furthermore, the label assignment work screen output units 13 and 13B may arrange utterance texts of the operator and utterance texts of the customer along a predetermined direction (for example, from left to right) in chronological order on the second label assignment work screen. Furthermore, the label assignment work screen output units 13 and 13B may arrange scene labels, requirement labels, and requirement confirmation labels assigned to the utterance texts in accordance with the positions of the utterance texts. A second label is a label having hierarchical structure in which a label cannot be independently assigned by one element and the label should be assigned in consideration of other elements. Therefore, as in the second label assignment work screen illustrated in FIG. 11B, the elements (utterance texts) are sequentially arranged along the predetermined direction, so that assigning labels in consideration of preceding and subsequent elements is facilitated. As a result, the work efficiency of label assignment can be improved.

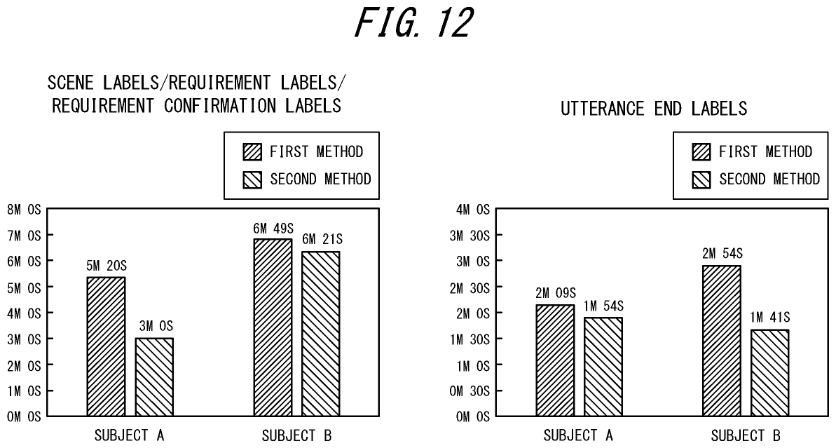

FIG. 12 is a diagram illustrating comparison results of work efficiency of label assignment by a conventional method of assigning labels by a worker from the beginning (first method) and a method of updating preliminary labels estimated by an existing model according to the present disclosure (second method). FIG. 12 illustrates time required for a subject A and a subject B to assign labels (scene labels, requirement labels, requirement confirmation labels, and utterance end labels) to utterance texts included in 14 calls by the first method and the second method. The subject A is a worker who has engaged in work of creating training data for several years and is skilled in label assignment. The subject B is a worker who has engaged in the work of creating training data for several months and is less skilled in label assignment than the subject A. The existing model used in the second method was created by learning training data for 100 calls.

As illustrated in FIG. 12, in assignment of the scene labels, the requirement labels, and the requirement confirmation labels, time required for label assignment by the second method is shorter than that by the first method for both the subject A and the subject B. Furthermore, similarly for the utterance end labels, time required for label assignment is shorter by the second method than that by the first method for both the subject A and the subject B. From the results, it has been found that, according to the present disclosure, workers can more easily and efficiently assign labels.

With regard to the above embodiments, the following supplementary notes are further disclosed.

### Supplement 1

A label assignment support device including
a memory, and
at least one of processor connected to the memory,
in which the processor
estimates preliminary labels that are labels for each of a plurality of elements using an existing model prepared in advance and assigns the preliminary labels to each of the plurality of elements,
generates a label assignment work screen for an update operation for labels assigned to the plurality of elements by a user, the label assignment work screen indicating each of the plurality of elements and labels assigned to each of the plurality of elements in association with each other, and outputs the label assignment work screen to an external input and output interface, and,
when a label assigned to one of the elements is updated by the update operation via the label assignment work screen, assigns the label after update to the one of the elements.

### Supplement 2

A label assignment support device including
a memory, and
at least one of processor connected to the memory,
in which the processor
generates a label assignment work screen for an update operation for labels assigned to the plurality of elements by a user, the label assignment work screen indicating each of the plurality of elements and labels assigned to each of the plurality of elements in association with each other, and outputs the label assignment work screen to an external input and output interface,
in which the labels include labels of a plurality of items, and
the processor arranges the plurality of elements in a line, and sorts and arranges labels of the plurality of items on one side and another side of elements corresponding to corresponding labels on the basis of structure of labels of the plurality of items on the label assignment work screen.

### Supplement 3

A label assignment support device including
a memory, and
at least one of processor connected to the memory,
in which the processor
generates a label assignment work screen for an update operation for labels assigned to the plurality of elements by a user, the label assignment work screen indicating each of the plurality of elements and labels assigned to each of the plurality of elements in association with each other, and outputs the label assignment work screen to an external input and output interface,
in which the labels include labels of a plurality of items, and
the output unit, when a label to be updated is selected or a label is updated on the label assignment work screen, changes a display mode of the label to be updated or a label associated with the updated label on the basis of hierarchical structure of labels of the plurality of items.

### Supplement 4

A non-transitory storage medium that stores a program that can be executed by a computer, the program causing the computer to function as the label assignment support device according to any one of supplements 1 to 3.

All documents, patent applications, and technical standards described in this specification are incorporated herein by reference to the same extent as if each individual document, patent application, and technical standard were specifically and individually described to be incorporated by reference.

### REFERENCE SIGNS LIST

1 External input and output interface
10, 10A, 10B
11 Preliminary label estimation unit
12, 12A Switching Unit
13, 13B Label assignment work screen output unit (output unit)
14 Label memory
15 Label update unit
21 Preliminary label correction unit
31 Highlighted word search unit
32 Voice extraction unit
33 Waveform image generation unit
110 Processor
120 ROM
130 RAM
140 Storage
150 Input unit
160 Display unit
170 Communication interface
190 Bus

1. A label assignment support device for supporting label assignment for each of a plurality of elements, the label assignment support device comprising processing circuitry configured to:
estimate preliminary labels that are labels for each of the plurality of elements using an existing model prepared in advance and assign the preliminary labels to each of the plurality of elements;
generate a label assignment work screen for an update operation for labels assigned to the plurality of elements by a user, the label assignment work screen indicating each of the plurality of elements and labels assigned to each of the plurality of elements in association with each other, and output the label assignment work screen to an external input and output interface; and
when a label assigned to one of the elements is updated by the update operation via the label assignment work screen, assign the label after update to the one of the elements.

2. The label assignment support device according to claim 1,
wherein the labels include labels of a plurality of items, and
the processing circuitry arranges the plurality of elements in a line, and sorts and arranges labels of the plurality of items on one side and another side of elements corresponding to corresponding labels on a basis of structure of labels of the plurality of items on the label assignment work screen.

3. The label assignment support device according to claim 1,
wherein the labels include labels of a plurality of items, and
the processing circuitry, when a label to be updated is selected or a label is updated on the label assignment work screen, changes a display mode of the label to be updated or a label associated with the updated label on a basis of hierarchical structure of labels of the plurality of items.

4. The label assignment support device according to claim 1,
wherein the processing circuitry corrects a label determined to be erroneous on a basis of a predetermined rule among the estimated preliminary labels.

5. The label assignment support device according to claim 1,
wherein, in a case where the elements are utterance texts corresponding to utterance by each of a plurality of speakers in conversation by the plurality of speakers,
when one of the utterance texts is selected on the label assignment work screen, the processing circuitry outputs at least one of utterance voice corresponding to the selected utterance text or a waveform image of utterance voice corresponding to the selected utterance text to the external input and output interface.

6. The label assignment support device according to claim 1,
wherein the labels include first labels and second labels,
the first labels are labels of an item in which labels can be independently assigned,
the second labels are labels having hierarchical structure or labels of an item in which a label of one element is determined on a basis of a plurality of elements including the one element, and
the processing circuitry independently outputs a first label assignment work screen for an update operation of the first labels and a second label assignment work screen for an update operation of the second labels to the external input and output interface.

7. A label assignment support device for supporting label assignment for each of a plurality of elements, the label assignment support device comprising processing circuitry configured to generate a label assignment work screen for an update operation for labels assigned to the plurality of elements by a user, the label assignment work screen indicating each of the plurality of elements and labels assigned to each of the plurality of elements in association with each other, and output the label assignment work screen to an external input and output interface,
wherein the labels include labels of a plurality of items, and
the processing circuitry arranges the plurality of elements in a line, and sorts and arranges labels of the plurality of items on one side and another side of elements corresponding to corresponding labels on a basis of structure of labels of the plurality of items on the label assignment work screen.

8. A label assignment support device for supporting label assignment for each of a plurality of elements, the label assignment support device comprising processing circuitry configured to generate a label assignment work screen for an update operation for labels assigned to the plurality of elements by a user, the label assignment work screen indicating each of the plurality of elements and labels assigned to each of the plurality of elements in association with each other, and output the label assignment work screen to an external input and output interface,
wherein the labels include labels of a plurality of items, and
the processing circuitry, when a label to be updated is selected or a label is updated on the label assignment work screen, changes a display mode of the label to be updated or a label associated with the updated label on a basis of hierarchical structure of labels of the plurality of items.

9. A label assignment support method for supporting label assignment for each of a plurality of elements, the label assignment support method comprising:
estimating preliminary labels that are labels for each of the plurality of elements using an existing model prepared in advance and assigning the preliminary labels to each of the plurality of elements;
generating a label assignment work screen for an update operation for labels assigned to the plurality of elements by a user, the label assignment work screen indicating each of the plurality of elements and labels assigned to each of the plurality of elements in association with each other, and outputting the label assignment work screen to an external input and output interface; and
when a label assigned to one of the elements is updated by the update operation via the label assignment work screen, assigning the label after update to the one of the elements.

10. A non-transitory computer readable recording medium
recording a program for causing a computer to function as the label assignment support device according to claim 1.
